(19) United States
(12) Patent Application Publication
(10) Pub. No.: US 2009/0324806 A1
(43) Pub. Date: Dec. 31, 2009

(54) METHOD AND APPARATUS FOR DISPENSING A VISCOUS FLUID

(76) Inventors: Cem Yavaser, Azmoos (CH); Bernd Heinz, Buchs (CH)

Correspondence Address: PEARNE & GORDON LLP, 1801 EAST 9TH STREET, SUITE 1200, CLEVELAND, OH, 44114-3108, US

(21) Appl. No.: 12/028,195

(22) Filed: Feb. 8, 2008

Related U.S. Application Data
(60) Provisional application No. 60/889,351, filed on Feb. 12, 2007.

(51) Int. Cl. B05D 5/12

(52) U.S. Cl. 427/58

(57) ABSTRACT

A method for dispensing a viscous liquid onto a rotating, disk-shaped substrate comprises the steps of Positioning the tip of a nozzle for dispensing said viscous liquid at a first distance relative to a surface of said substrate during start of the dispensing, thereby allowing the viscous liquid (4) to make a controlled first contact with the substrate. Then the gap between said nozzle and the surface of said substrate is increased to a second distance during dispensing. Accordingly, an apparatus for dispensing a viscous liquid comprises a nozzle with a tip for dispensing said viscous liquid and means for changing the distance between said nozzle and the surface of said substrate.

This application claims benefit from prior application U.S. 60/889,351, which is incorporated herewith by reference.

This invention generally relates to the field of spin coating on substrates, especially to a method and apparatus for dispensing lacquer air bubble free onto a substrate.

### BACKGROUND OF THE INVENTION

It is well known in the prior art, especially in the field of semi-conductor manufacturing but also in certain areas of optics or biotechnology, that a homogeneous distribution of liquids on an essentially plane substrate may be achieved by rotating (spinning) a substrate around an axis normal to the plane given by its surface. By applying a viscous liquid onto the surface during spinning centrifugal forces effect a distribution of the liquid radially outwards over the surface. Such “spinning” technique is used to apply e.g. lacquer, resins or photo resist on semiconductor substrates. Moreover it is utilised in the production of substrates in optical data storage technology to provide an essentially homogeneous layer of resin, lacquer, adhesive etc. A special case is the production of all type of DVD and Blu Ray Disc formats. A standard process for such a distribution method is:
1) Dispensing a liquid on the substrate to be coated; eventually rotating it slowly during this step to achieve an advantageous initial spreading.
2) Spinning the disk at high speed (typically a few hundred rpm up to 12.000 rpm) to homogeneously distribute the liquid.

### PROBLEMS IN THE ART

To ensure a defect free and tangentially homogeneous spin coated layer, the dispensing of the liquid onto the substrate has to be controlled very carefully. On the other hand, using spin-coating for mass manufacturing (e.g. optical discs), the time used for dispensing and spinning has to be minimized for cost efficient production.

For substrates with a centre hole, typically used in optical storage industry, the lacquer has to be dispensed initially in a ring shape around the centre hole. For achieving the required homogeneous distribution, the lacquer is dispensed onto the substrate using more then one revolution.

### EXAMPLE

To produce the 100 micron cover layer of a Blu Ray Disc media, a lacquer ring is dispensed at a radius of typically 14 mm. The volume dispensed per disk is typically 3 cm³. The lacquer is dispensed during 3 revolutions using a rotation speed of 110 rpm. The dispense needle/dispense nozzle height is around 5 mm in minimum, calculated between needle and substrate as shown below.

The dispense nozzle height during dispensing has to be adjusted to avoid a contact between the nozzle and the lacquer ring, dispensed during the preceding revolutions. Therefore the height of the lacquer ring just after dispensing restricts the minimum height of the dispense nozzle during the dispensing process.

It is known that air can be trapped in between the out-flowing lacquer and the substrate surface, especially in the moment when the lacquer makes the first contact with the substrate. This effect is governed by the surface tension of the lacquer and the substrate. The risks to trap some air is higher with increasing dispense needle height, because a lacquer droplet tends to form at the needle tip before the lacquer contacts the disk surface. The droplet formation will increase the contact surface between lacquer and disk which increases the probability of trapping air. Finally the trapped air can be seen on the surface of the spin coated substrate as defects, making the substrates useless.

### BRIEF DESCRIPTION OF THE DRAWINGS

FIG. 1 shows the start of the dispensing step according to the invention.

FIG. 2 shows a later phase of the dispensing step.

FIG. 3 shows dispense needle height profiles according to the invention.

### SUMMARY OF THE INVENTION

A method for dispensing a viscous liquid (4) onto a rotating, disk-shaped substrate (5) comprises the steps of a) Positioning the tip of a nozzle (2) for dispensing said viscous liquid (4) at a first distance (3) relative to a surface of said substrate (5) during start of the dispensing, thereby allowing the viscous liquid (4) to make a controlled first contact with the substrate (5). Further, b) the gap between said nozzle (2) and the surface of said substrate (5) is being increased to a second distance (6) during dispensing. This step of increasing the gap is being performed following a continuous or stepwise height profile. An inventive apparatus for dispensing a viscous liquid (4) onto a rotating, disk-shaped substrate (5) is comprising a nozzle (2) with a tip for dispensing said viscous liquid (4) and means for changing the distance between said nozzle (2) and the surface of said substrate (5) during dispensing.

### DETAILED DESCRIPTION OF THE INVENTION

To avoid air bubble formation during dispensing the dispense needle height is controlled during the dispensing step. In one embodiment, a servo motor can control the nozzle height.

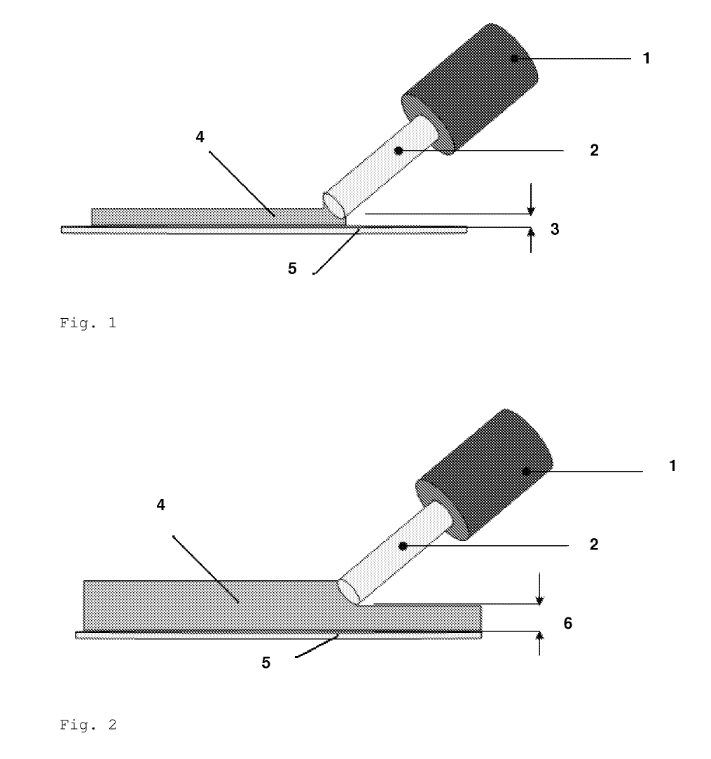

As shown in FIG. 1, during the start of dispensing the tip of the dispense nozzle 2 is very close to the surface of the disk 5. Reference 3 shows the dispense nozzle height during dispense start. Thereby the out-flowing lacquer 4 makes a controlled first contact with the disk. The risk of some air bubbles being trapped is minimized.

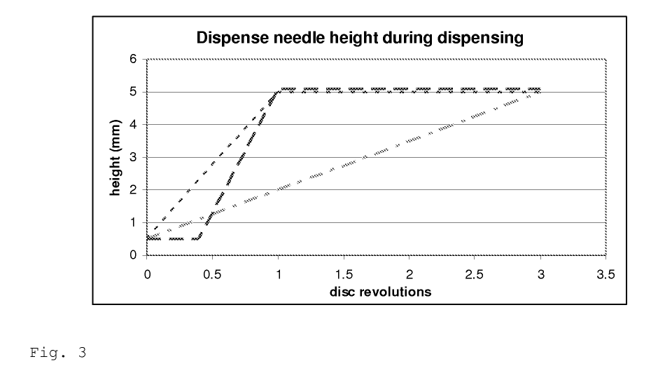

As further explained in FIG. 2, during the first revolution (and during the subsequent dispense revolutions), the nozzle height has to be increased to avoid the contact between nozzle and lacquer dispensed during preceding revolutions. This change of height is displayed by reference numeral 6. In both FIGS. 1 and 2 reference numeral 1 shows a dispense valve used to control the flow of lacquer.

The possibility to change the dispense needle height during dispensing allows to run different height profiles during the dispensing. 3 examples of advantageous profiles are shown in FIG. 3:

In general, the needle is very close to the disk surface during the dispense start and the height is maximum at the dispense end. In practice an initial value of 0.5 mm for the dispense nozzle height (distance between lower edge of the nozzle and the substrate, as shown in the respective figure) is being increased to an end value as necessary. The man skilled in the art will choose the upper value according to the viscosity of the liquid and the volume of liquid to be dispensed. Values between 0.5 and 5 mm have been tested with a preferred value of 2.5 mm for the dispense needle height at the end of the dispensing process.

### FURTHER ADVANTAGES OF THE INVENTION

The improved control of the first contact between the lacquer and the disc allows the usage of a bigger needle diameter. A needle with a bigger diameter is usually more sensitive to the air trapping problem. On the other hand the bigger diameter allows dispensing the required lacquer volume in a shorter time. This allows to shorten the machine cycle time and increases the output rate.

1. Method for dispensing a viscous liquid (4) onto a rotating, disk-shaped substrate (5) comprising the following steps:
Positioning the tip of a nozzle (2) for dispensing said viscous liquid (4) at a first distance (3) relative to a surface of said substrate (5) during start of the dispensing, thereby allowing the viscous liquid (4) to make a controlled first contact with the substrate (5);
Increasing the gap between said nozzle (2) and the surface of said substrate (5) to a second distance (6) during dispensing.

2. Method according to claim 1, wherein said step of increasing the gap is being performed at least during the first revolution of the substrate (5).

3. Method according to claim 1, wherein said step of increasing the gap is being performed during all dispense revolutions.

4. Method according to claim 1, wherein said step of increasing the gap is being performed following a continuous or stepwise height profile.

5. Method according to claim 1 to 4, wherein said first distance (3) equals essentially 0.5 mm and said second distance (6) corresponds to 2.5 to 5 mm

6. Apparatus for dispensing a viscous liquid (4) onto a rotating, disk-shaped substrate (5) comprising a nozzle (2) with a tip for dispensing said viscous liquid (4) and means for changing the distance between said nozzle (2) and the surface of said substrate (5) during dispensing.

7. Apparatus according to claim 6, wherein said means is being relized by a servo motor.
